(19) United States
(12) Patent Application Publication
(10) Pub. No.: US 2012/0179373 A1
(43) Pub. Date: Jul. 12, 2012

(54) METHOD FOR MEASURING TOTAL PHOSPHORUS USING MULTI-PARAMETER WATER QUALITY DATA

(75) Inventors: Chang Won LEE, Osan-si (KR); Gwan Joong KIM, Daejeon (KR); Nae Soo KIM, Daejeon (KR); Hoon JEONG, Daejeon (KR); Young Hwan HAM, Daejeon (KR); Hyun Ook KIM, Seoul (KR)

(73) Assignees: University of Seoul Industry Cooperation Foundation, Seoul (KR); Electronics and Telecommunications Research Institute, Daejeon (KR)

(21) Appl. No.: 13/348,421

(22) Filed: Jan. 11, 2012

(30) Foreign Application Priority Data
Jan. 11, 2011 (KR) 10-2011-0002601
Oct. 17, 2011 (KR) 10-2011-0106015

(51) Int. Cl. G06F 19/00

(52) U.S. Cl. 702/2

(57) ABSTRACT

Provided are a method and a system for measuring total phosphorus that may predict total phosphorus of a river valley using multi-parameter water quality that are measured in real time through a multi-parameter water quality measuring unit and the like, and may increase the accuracy thereof. The total phosphorus measuring method according to the present disclosure includes: computing a correlation between the multi-parameter water quality and the total phosphorus using multi-parameter water quality data and total phosphorus data measured for a predetermined period; selecting upper parameters having a high correlation from among the multi-parameter water quality based on the computation result; generating a total phosphorus prediction model through a regression analysis between the upper parameters and the total phosphorus; measuring the multi-parameter water quality; and predicting the total phosphorus by replacing the total phosphorus prediction model with the measured multi-parameter water quality.

### CROSS-REFERENCE TO RELATED APPLICATIONS

This application is based on and claims priority from Korean Patent Application No. 10-2011-0002601, filed on Jan. 11, 2011, and Korean Patent Application No. 10-2011-0106015, filed on Oct. 17, 2011 with the Korean Intellectual Property Office, the disclosure of which is incorporated herein in its entirety by reference.

### TECHNICAL FIELD

The present disclosure relates to a technology of measuring total phosphorus using multi-parameter water quality (water temperature, electric conductivity, dissolved oxygen, turbidity, chlorophyll, oxidation-reduction intensity, hydrogen ion concentration, and the like), and enhancing the accuracy thereof.

### BACKGROUND

Phosphorus is a representative nutrient that causes a algal bloom together with nitrogen. In general, phosphorous flows in a river as a main component of a synthetic detergent and fertilizer, and total phosphorus is used as a criterion that indicates eutrophication of the water quality. As a related method of measuring total phosphorus, there are a method of sampling corresponding stream water and thereby analyzing and measuring the sampled stream water in a laboratory, and a method of employing a measurement device currently used in the National Automatic Water Quality Measuring Network in Korea. However, such methods may not measure the water quality within a short time and thus, may not quickly monitor a change in the water quality. That is, in a water quality measuring method according to a related art, since at least a minimum of one hour of a measurement time is required, it is difficult to monitor the change in the water quality in real time in a place where the velocity of flowing fluid is quick or where a water intake is positioned.

According to research, chemical water quality parameters have mutual correlation and thus, it is possible to measure another water quality parameter using the other chemical water quality parameters. Currently, research on a method of estimating an amount of nutrients such as total nitrogen, total phosphorus, and the like, using biochemical water quality parameters is being conducted. However, the level of research remains at a level that requires to correlate measurement values over a span of a few years. Since a characteristic of a river valley appears differently for each valley (for example, a water system in the Han River and a water system in the Nakdong River have different characteristics due to different population density and agricultural industrial complex, and different types of river branches and extraneous water), a relational analysis method dependent on multi-parameter water quality data within the span of a few years cannot be integrally applied to all of river valleys.

In the case of stream water, water pollution may proceed quickly due to various industrial activities by human beings. Depending on cases, irreconcilable damage may occur in an instant and thus, there is a need to quickly verify whether water pollution has occurred such that immediate action can be initiated. Total phosphorus is used as a standard to verify whether water pollution has occurred. In the related art, only when measurement data of at least a minimum of one hour is collected at least several times, can water pollution be determined in order to prepare countermeasures for the water pollution. Accordingly, there is a problem in that it is difficult to quickly handle the occurrence of water pollution.

### SUMMARY

The present disclosure has been made in an effort to provide a method and a system for measuring total phosphorus that may predict total phosphorus using multi-parameter water quality data that are measured in real time by a multi-parameter water quality measuring unit, and may increase the accuracy thereof.

An exemplary embodiment of the present disclosure provides a method of measuring total phosphorus using multi-parameter water quality data, the method including: computing a correlation between the multi-parameter water quality and the total phosphorus using the multi-parameter water quality data and total phosphorus data measured for a predetermined period; selecting upper parameters having a high correlation from among the multi-parameter water quality based on the computation result; generating a total phosphorus prediction model through a regression analysis between the upper parameters and the total phosphorus; measuring the multi-parameter water quality; and predicting the total phosphorus by replacing the total phosphorus prediction model with the measured multi-parameter water quality.

Another exemplary embodiment of the present disclosure provides a method of measuring total phosphorus using multi-parameter water quality data, the method including: computing a correlation between the multi-parameter water quality and the total phosphorus using the multi-parameter water quality data and total phosphorus data measured for a predetermined period; selecting upper parameters having a high correlation from among the multi-parameter water quality based on the computation result; generating a total phosphorus prediction model through a regression analysis between the upper parameter and the total phosphorus; measuring the multi-parameter water quality at first time intervals; predicting the total phosphorus at the first time intervals by replacing the total phosphorus prediction model with the measured multi-parameter water quality; measuring the total phosphorus at second time intervals greater than the first time interval; computing accuracy of the total phosphorus prediction model by comparing the average of the total phosphorus measured at the second time intervals and the total phosphorus predicted for the second time interval; and updating the total phosphorus prediction model when the accuracy is less than a predetermined value.

The generating of the total phosphorus prediction model may include: generating a regression model by performing the regression analysis using the upper parameter as an independent variable and using the total phosphorus as a dependent variable; performing a variance analysis with respect to the regression model; determining a criterion parameter to be used for the total phosphorus prediction model among the upper parameters using the variance analysis result; and computing a regression coefficient with respect to the criterion parameter.

The updating of the total phosphorus prediction model may include: configuring a plurality of measurement data sets by varying a measurement period with respect to the multi-parameter water quality and the total phosphorus from a latest measurement point in time of the total phosphorus; generating a regression model with respect to each of the plurality of measurement data sets, and computing accuracy; and selecting, as the total phosphorus prediction model, a regression model having the highest accuracy based on the computation result.

Yet another exemplary embodiment of the present disclosure provides a system for measuring total phosphorus using multi-parameter water quality data, the system including: a water quality measuring unit to measure multi-parameter water quality of a river; a total phosphorous measuring unit to measure total phosphorus of the river; a measurement data storing unit to database the measured multi-parameter water quality and total phosphorus to correspond to a measurement point in time; and an analyzing/computing unit to compute a correlation between the multi-parameter water quality and the total phosphorus using measurement data that are measured for a predetermined period with respect to the multi-parameter water quality and the total phosphorus of the river, to select an upper parameter having a high correlation from among the multi-parameter water quality data and thereby generate a total phosphorus prediction model through a regression analysis between the upper parameter and the total phosphorus, and to predict the total phosphorus by replacing the total phosphorus prediction model with the multi-parameter water quality measured by the water quality measuring unit.

According to the exemplary embodiments of the present disclosure, it is possible to predict total phosphorus with at least a predetermined level of accuracy according to a measurement period of multi-parameter water quality by generating a total phosphorus prediction model through a regression analysis between multi-parameter water quality and the total phosphorus of a river, and employing the generated total phosphorus prediction model. Through this, it is possible to monitor in real time whether water quality in a river valley is polluted, and to thereby quickly prepare countermeasures.

It is possible to guarantee the accuracy and reliability of the total phosphorus prediction model by continuously updating the total phosphorus prediction model using total phosphorus data that is measured for a recent variable period.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a flowchart illustrating a method of measuring total phosphorus using multi-parameter water quality data according to an exemplary embodiment of the present disclosure.

FIG. 2 is a flowchart illustrating a prediction model generating step of FIG. 1 in detail.

FIG. 3 is a flowchart illustrating a method of measuring total phosphorus using multi-parameter water quality data according to another exemplary embodiment of the present disclosure.

FIG. 4 is a flowchart illustrating a prediction model updating step of FIG. 3 in detail.

FIG. 5 is a configuration diagram illustrating a system for measuring total phosphorus using multi-parameter water quality data according to an exemplary embodiment of the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

The aforementioned objectives, features, and advantages will be described in detail with reference to the accompanying drawings and thus, those skilled in the art may easily implement the technical spirit of the present disclosure. When it is determined that detailed description related to a known function or configuration may make the purpose of the present disclosure unnecessarily ambiguous in describing the present disclosure, the detailed description will be omitted. Hereinafter, exemplary embodiments of the present disclosure will be described in detail with reference to the accompanying drawings.

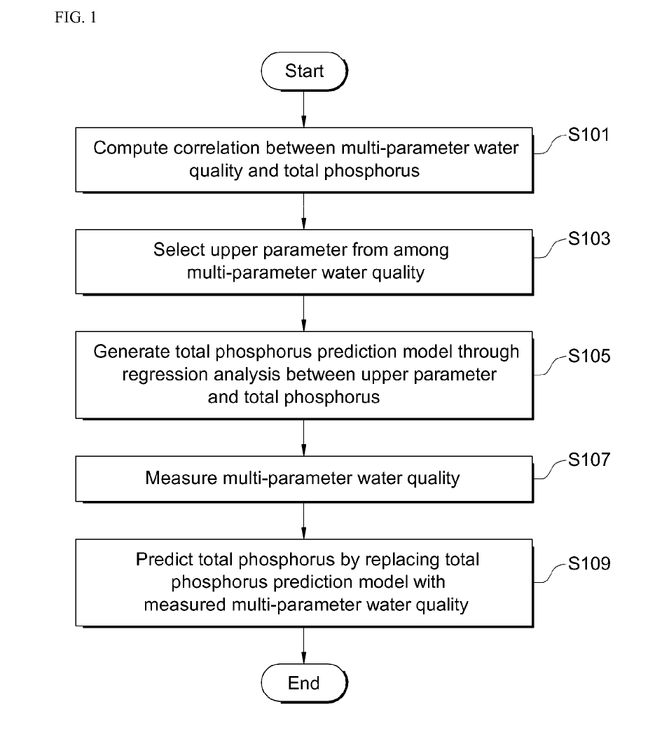

FIG. 1 is a flowchart illustrating a method of measuring total phosphorus using multi-parameter water quality data according to an exemplary embodiment of the present disclosure.

Referring to FIG. 1, the total phosphorous measuring method according to the exemplary embodiment of the present disclosures includes step S101 of computing a correlation between the multi-parameter water quality and the total phosphorus using data measured for a predetermined period, step S103 of selecting upper parameters from among the multi-parameter water quality, step S105 of generating a total phosphorus prediction model through a regression analysis between the selected upper parameter and the total phosphorus, step S107 of measuring the multi-parameter water quality, and step S109 of predicting the total phosphorus by replacing the total phosphorus prediction model with the measured multi-parameter water quality.

Here, the multi-parameter water quality include water temperature, electric conductivity, dissolved oxygen, turbidity, chlorophyll, oxidation-reduction intensity, and hydrogen ion concentration.

According to an exemplary embodiment of the present disclosure, by analyzing a plurality of multi-parameter water quality data and total phosphorus data that have been measured for a predetermined period (for example, for one to three years) in a predetermined river, a correlation between the multi-parameter water quality and the total phosphorus is computed (S101), and an upper parameter having a high correlation as the computation result is selected (S103). In this instance, one to three parameters having the highest correlation among the above seven multi-parameter water quality may be selected as the upper parameter. In the present exemplary embodiment, it is assumed that three parameters are selected as the upper parameters.

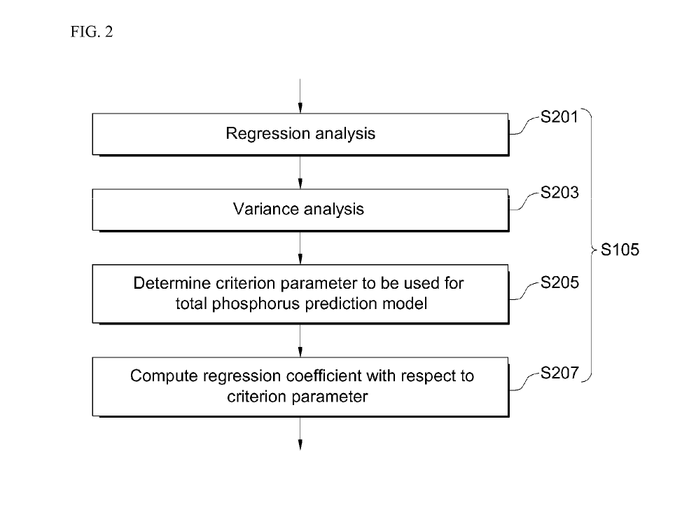

When the correlation analysis is completed, the total phosphorus prediction model is generated through a regression analysis between the selected upper parameters and the total phosphorus (S105), which will be described later with reference to FIG. 2.

Next, the multi-parameter water quality are measured in real time using a multi-parameter water quality measuring unit that is installed in a corresponding river valley (S107), and the total phosphorus is predicted by replacing the generated total phosphorus prediction model with the measured data (S109).

Currently, at least a minimum of one hour interval is required to consecutively measure a total phosphorus value using a total phosphorus measuring unit. When measuring the total phosphorus through a water analysis in a laboratory, it takes several days. Accordingly, it is difficult to verify the variability thereof in real time through the measured value of the total phosphorus. On the other hand, in the case of measuring the multi-parameter water quality using a water quality sensor and the like, a consecutive measurement can be performed based on a unit of minimum five seconds. Therefore, by generating and employing a regression model (prediction model) capable of predicting the total phosphorus with at least a predetermined level of accuracy using the multi-parameter water quality, it is possible to verify the variability of the total phosphorus value in the river valley in real time.

Meanwhile, the river may have various characteristics depending on topography, the neighboring agriculture, farming, industrial complex, and population density. Accordingly, it is presumed that a data analysis and total phosphorus prediction technology disclosed in the present disclosure is configured independently for each river. To apply the present disclosure to the river of which water quality measurement is newly started, collection of data for a predetermined period is required.

FIG. 2 is a flowchart illustrating a prediction model generating step S105 of FIG. 1 in detail.

Referring to FIG. 2, prediction model generating step S105 may include regression analysis step S201 with respect to upper parameters that are selected from among the multi-parameter water quality, variance analysis step S203, criterion parameter determining step S205 of determining a criterion parameter to be used for a prediction model, and regression coefficient computing step S207 with respect to the criterion parameter.

In regression analysis step S201, a regression model is generated by performing a multi-linear regression analysis using the three upper parameter data, used for correlation computation, as independent variables and using total phosphorus data as a dependent variable. Next, in variance analysis step S203, the variance analysis is performed with respect to the generated regression model. Through this, a parameter most suitable for the total phosphorus prediction model for the total phosphorus computation, that is, the criterion parameter to be used for the total phosphorus prediction model is determined among the three upper parameters (S205). When the criterion parameter is determined, a regression coefficient with respect to the criterion parameter is computed whereby the total phosphorus prediction model is finally generated (S207).

For example, when all of three upper parameters are suitable for an idealistic linear regression model, all of the three upper parameters may be used as the criterion parameter. On the contrary, when a computed value with respect to the accuracy with the actual total phosphorus does not reach a predetermined level (for example, 70%) as the realization result of the regression model using the three upper parameters, the linear regression model using only turbidity as the criterion parameter may be generated as the total phosphorus prediction model. Only the turbidity may be selected as the criterion parameter since phosphorus has a strong propensity of being adhered to suspended solids underwater and appears in proportion to a turbidity value due to a characteristic of phosphorus.

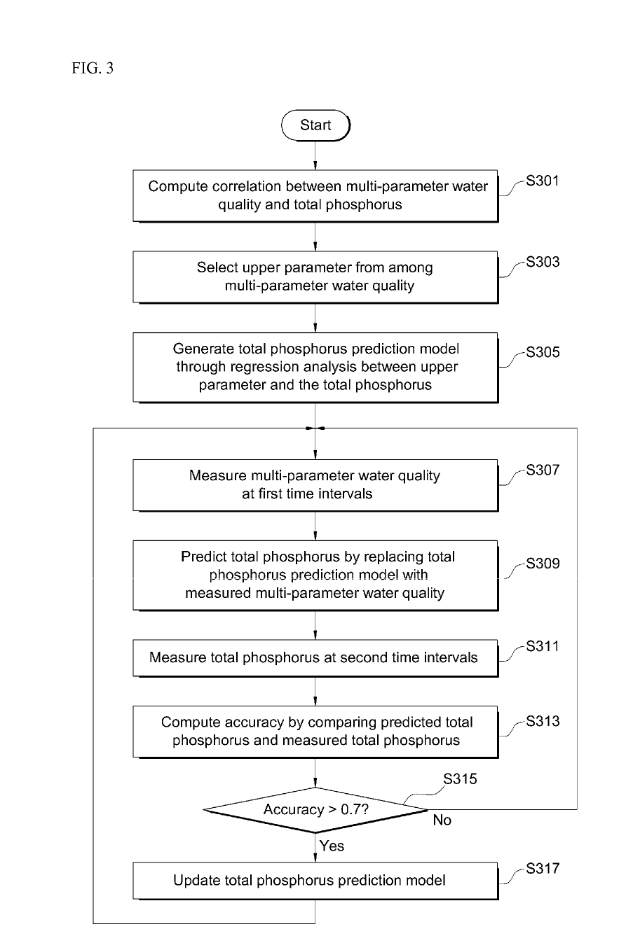

FIG. 3 is a flowchart illustrating a method of measuring total phosphorus using multi-parameter water quality data according to another exemplary embodiment of the present disclosure

Referring to FIG. 3, the total phosphorus measuring method according to another exemplary embodiment of the present disclosure includes step S301 of computing a correlation between the multi-parameter water quality and the total phosphorus using data measured for a predetermined period, step S303 of selecting upper parameters from among the multi-parameter water quality, step S305 of generating a total phosphorus prediction model through a regression analysis between the selected upper parameter and the total phosphorus, step S307 of measuring the multi-parameter water quality at first time intervals, step S309 of predicting the total phosphorus at the first time intervals by replacing the total phosphorus prediction model with the measured multi-parameter water quality, step S311 of measuring the total phosphorus at second time intervals, step S313 of computing accuracy of the total phosphorus prediction model by comparing the predicted total phosphorus and the measured total phosphorus, and steps S315 and S317 of updating the total phosphorus prediction model when the accuracy is less than a predetermined value.

Correlation computing step S301, upper parameter selecting step S303, and total phosphorus prediction model generating step S305 of the present exemplary embodiment are the same as steps S101, S103, and S105 that are described above with reference to FIG. 1 and FIG. 2.

When the total phosphorus prediction model is generated, the multi-parameter water quality are measured at first time intervals (for example, every five seconds) through a water quality sensor and the like installed in a predetermined river valley (S307). The total phosphorus may be predicted at first time intervals by replacing the total phosphorus prediction model with the measured multi-parameter water quality (S309).

To secure the reliability of the predicted total phosphorus, the present exemplary embodiment employs a method of computing the accuracy of the total phosphorus prediction model at predetermined time intervals and updating the total phosphorus prediction model using latest measured data when the accuracy decreases to be less than a predetermined value. Specifically, a total phosphorus value is measured at second time intervals (for example, at least every one hour) through the total phosphorus measuring unit (S311). The accuracy of the total phosphorus prediction model is computed by comparing the predicted total phosphorus and the measured total phosphorus (S313). For example, if the multi-parameter water quality are measured every five minutes and the total phosphorus is measured every one hour, it is possible to compute the accuracy by comparing the average of 12 prediction values of the total phosphorus by the respective multi-parameter water quality measured 12 times for one hour, with a measurement value of the total phosphorus that is measured one time. The accuracy is computed according to the following equation:

$$Accuracy = \frac{\vert prediction value - measurement value \vert}{measurement value}$$

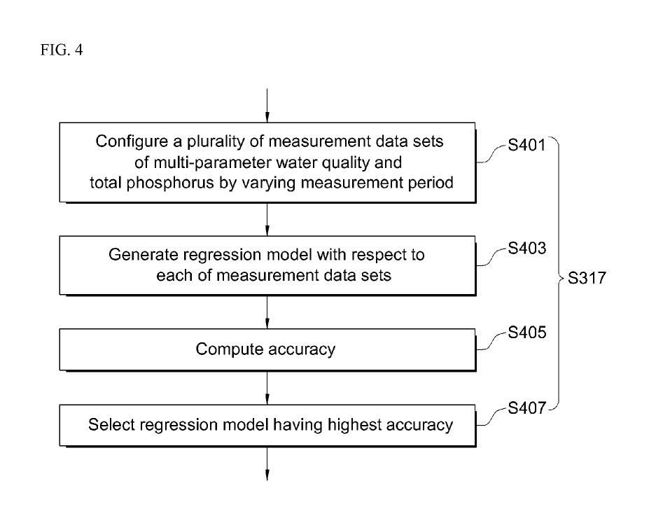

When the accuracy is greater than a predetermined value (for example, 0.7) as the computation result, the total phosphorus prediction model being used is reliable and thus, is used by a subsequent measurement point in time of the total phosphorus. However, when the accuracy is computed to be less than the predetermined value, the total phosphorus prediction model is updated (S315 and S317). Hereinafter, prediction model updating step S317 will be described in detail with reference to FIG. 4.

FIG. 4 is a flowchart illustrating prediction model updating step S317 of FIG. 3 in detail.

Initially, a measurement data set related to multi-parameter water quality and total phosphorus from a latest measurement point in time of the total phosphorus to a previous predetermined point in time thereof is configured (S401). In this instance, a plurality of measurement data sets may be configured by varying a measurement period. For example, measurement data sets of variable periods from the latest measurement point in time to previous 12 hours, 1 day, 7 days, 15 days, 30 days, 3 months, and the like, thereof may be configured. In the present exemplary embodiment, it is assumed that three measurement data sets of 1 day, 7 days, and 30 days are configured. The number of measurement data sets may be determined based on a system specification in which the present disclosure is implemented. If a system can perform a computation with respect to the more number of data sets within a very short time in a hardware manner or in a software manner, the number of data sets may be further increased in order to obtain the high accuracy.

Next, three regression models are generated by performing the regression analysis to each of the measurement data sets (S403). The accuracy is computed by comparing the prediction value and the measurement value of the total phosphorous that are obtained using the generated regression models (S405). A regression model having the highest accuracy as the computation result is selected as the total phosphorus prediction model (S407).

As described above, when the accuracy of the total phosphorus prediction model based on existing measurement data is degraded, the reliability may be guaranteed by updating the total phosphorus prediction model using the latest measured multi-parameter water quality and total phosphorus data. In particular, even with respect to the latest data, it is possible to further increase the accuracy and reliability of the total phosphorus prediction model by configuring a plurality of measurement data sets that are obtained by varying a measurement period, and by selecting a measurement data set having the highest accuracy from among the plurality of measurement data sets.

By verifying a change in the prediction value of the total phosphorus using the aforementioned method, whether the river is polluted may be determined based on measurement periods of the multi-parameter water quality data. That is, the water pollution determination by the total phosphorus that is measured at a minimum of one hour interval may be performed to be within minimum five seconds interval. Through accuracy improvement with total phosphorus data that is measured at minimum one hour intervals, it is possible to improve the reliability of determining whether the river is polluted, and to actively prevent the water from being polluted.

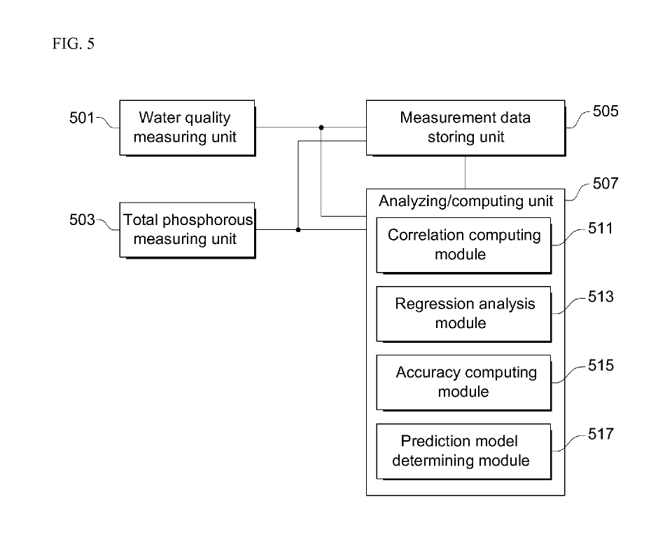

FIG. 5 is a configuration diagram illustrating a system for measuring total phosphorus using multi-parameter water quality data according to an exemplary embodiment of the present disclosure.

Referring to FIG. 5, the total phosphorus measuring system using the multi-parameter water quality data according to the exemplary embodiment of the present disclosure includes a water quality measuring unit 501 to measure multi-parameter water quality of a river, a total phosphorous measuring unit 503 to measure total phosphorus of the river, a measurement data storing unit 505 to database the measured multi-parameter water quality and total phosphorus to correspond to a measurement point in time, and an analyzing/computing unit 507 to compute a correlation between the multi-parameter water quality and the total phosphorus using measurement data that are measured for a predetermined period with respect to the multi-parameter water quality of the river and the total phosphorus, to select an upper parameter having a high correlation from among the multi-parameter water quality and thereby generate a total phosphorus prediction model through a regression analysis between the upper parameter and the total phosphorus, and to predict the total phosphorus by replacing the total phosphorus prediction model with the multi-parameter water quality measured by the water quality measuring unit 501.

The water quality measuring unit 501 may be installed in a river valley in a form of a water quality sensor and the like, and may transmit and receive data to and from the measurement data storing unit 505 and the analyzing/computing unit 507 over various types of wired/wireless networks such as a ubiquitous sensor network (USN), a code division multiple access (CDMA), a wideband code division multiple access (WCDMA), a wireless local area network (WLAN), and the like. The water quality measuring unit 501 may measure a plurality of multi-parameter water quality (water temperature, electric conductivity, dissolved oxygen, turbidity, chlorophyll, oxidation-reduction intensity, hydrogen ion concentration, and the like) at least every five seconds.

The total phosphorus measuring unit 503 may be installed in the river valley together with the water quality measuring unit 501 to measure an amount of total phosphorus at least every one hour.

The measurement data storing unit 505 stores measurement data that is collected from the water quality measuring unit 501 and the total phosphorus measuring unit 503. In this instance, the measurement data may be configured as a data set corresponding to a predetermined period, for example, a period of 12 hours, 1 day, 7 days, 15 days, 30 days, and the like, from the latest measurement point in time and thereby be stored.

The analyzing/computing unit 507 performs functionalities such as various types of statistical analyses with respect to the multi-parameter water quality data and total phosphorus data, generation of the total phosphorus prediction model, real-time prediction of the total phosphorus using the measured multi-parameter water quality, computation of the accuracy thereof, and the like. In particular, when the accuracy of the total phosphorus prediction model is less than a predetermined value, the analyzing/computing unit 507 functions to generate a regression model with respect to each of the plurality of measurement data sets that are obtained by varying the measurement period, to compute accuracy of each of the generated regression models, to select, as a new total phosphorus prediction model, a regression model having the highest accuracy, and to thereby update the total phosphorus prediction model.

For this, the analyzing/computing unit 507 may be configured to include a correlation computing module 511 to compute a correlation between the multi-parameter water quality and the total phosphorus using data that is measured for a predetermined period and is stored, a regression analysis module 513 to perform a regression analysis, a variance analysis, and the like between an upper parameter having a high correlation among the multi-parameter water quality and the total phosphorus, an accuracy computing module 515 to compute accuracy of a regression model generated through the regression analysis, and accuracy of the total phosphorus prediction model, and the like, and a prediction model determining module 517 to determine and update the total phosphorus prediction model for the accurate total phosphorous prediction among the generated regression models.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A method of measuring total phosphorus using multi-parameter water quality data, comprising:
computing a correlation between the multi-parameter water quality and the total phosphorus using the multi-parameter water quality data and the total phosphorus data measured for a predetermined period;
selecting upper parameters having a high correlation from among the multi-parameter water quality data based on the computation result;
generating a total phosphorus prediction model through a regression analysis between the upper parameter and the total phosphorus;
measuring the multi-parameter water quality; and
predicting the total phosphorus by replacing the total phosphorus prediction model with the measured multi-parameter water quality.

2. The method of claim 1, wherein the generating of the total phosphorus prediction model includes:
generating a regression model by performing the regression analysis using the upper parameter as an independent variable and using the total phosphorus as a dependent variable;
performing a variance analysis with respect to the regression model;
determining a criterion parameter to be used for the total phosphorus prediction model among the upper parameters using the variance analysis result; and
computing a regression coefficient with respect to the criterion parameter.

3. The method of claim 1, wherein the multi-parameter water quality include water temperature, electric conductivity, dissolved oxygen, turbidity, chlorophyll, oxidation-reduction intensity, and hydrogen ion concentration.

4. The method of claim 3, wherein one to three parameters having the high correlation from among the seven multi-parameter water quality are selected as the upper parameters.

5. A method of measuring total phosphorus using multi-parameter water quality data, the method comprising:
computing a correlation between the multi-parameter water quality and the total phosphorus using the multi-parameter water quality data and total phosphorus data measured for a predetermined period;
selecting upper parameters having a high correlation from among the multi-parameter water quality data based on the computation result;
generating a total phosphorus prediction model through a regression analysis between the upper parameter and the total phosphorus;
measuring the multi-parameter water quality at first time intervals;
predicting the total phosphorus at the first time intervals by replacing the total phosphorus prediction model with the measured multi-parameter water quality;
measuring the total phosphorus at second time intervals greater than the first time interval;
computing accuracy of the total phosphorus prediction model by comparing the average of the total phosphorus measured at the second time intervals and the total phosphorus predicted for the second time interval; and
updating the total phosphorus prediction model when the accuracy is less than a predetermined value.

6. The method of claim 5, wherein the generating of the total phosphorus prediction model includes:
generating a regression model by performing the regression analysis using the upper parameter as an independent variable and using the total phosphorus as a dependent variable;
performing a variance analysis with respect to the regression model;
determining a criterion parameter to be used for the total phosphorus prediction model among the upper parameters using the variance analysis result; and
computing a regression coefficient with respect to the criterion parameter.

7. The method of claim 6, wherein the updating of the total phosphorus prediction model includes:
configuring a measurement data set of the multi-parameter water quality and the total phosphorus from a latest measurement point in time of the total phosphorus to a previous predetermined point in time thereof; and
re-computing the regression coefficient using the measurement data set.

8. The method of claim 6, wherein the updating of the total phosphorus prediction model includes:
configuring a plurality of measurement data sets of the multi-parameter water quality and the total phosphorus from a latest measurement point in time of the total phosphorus by varying a measurement period;
generating a regression model with respect to each of the plurality of measurement data sets, and computing accuracy; and
selecting, as the total phosphorus prediction model, a regression model having the highest accuracy based on the computation result.

9. The method of claim 5, wherein a minimum value of the first time interval is five seconds and a minimum value of the second time interval is 1 hour.

10. The method of claim 5, wherein the multi-parameter water quality include water temperature, electric conductivity, dissolved oxygen, turbidity, chlorophyll, oxidation-reduction intensity, and hydrogen ion concentration.

11. The method of claim 10, wherein one to three parameters having the high correlation from among the seven multi-parameter water quality are selected as the upper parameters.

12. A system for measuring total phosphorus using multi-parameter water quality data, the system comprising:
a water quality measuring unit to measure the multi-parameter water quality of a river;
a total phosphorous measuring unit to measure the total phosphorus of the river;
a measurement data storing unit to database the measured multi-parameter water quality and the total phosphorus to correspond to a measurement point in time; and
an analyzing/computing unit to compute a correlation between the multi-parameter water quality and the total phosphorus using measurement data that are measured for a predetermined period with respect to the multi-parameter water quality data and the total phosphorus of the river, to select upper parameters having a high correlation from among the multi-parameter water quality and thereby generate a total phosphorus prediction model through a regression analysis between the upper parameters and the total phosphorus, and to predict the total phosphorus by replacing the total phosphorus prediction model with the multi-parameter water quality measured by the water quality measuring unit.

13. The system of claim 12, wherein:
the water quality measuring unit measures the multi-parameter water quality at first time intervals,
the total phosphorus measuring unit measures the total phosphorus at second time intervals greater than the first time interval, and the analyzing/computing unit predicts the total phosphorus by replacing the total phosphorus prediction model with the multi-parameter water quality measured at the first time intervals, and computes accuracy of the total phosphorus prediction model by comparing the average of the total phosphorus measured at the second time intervals and the total phosphorus predicted for the second time interval.

14. The system of claim 13, wherein the measurement data storing unit configures a plurality of measurement data sets of the multi-parameter water quality data and the total phosphorus from a latest measurement point in time of the total phosphorus by varying a measurement period.

15. The system of claim 14, wherein when the accuracy of the total phosphorus prediction model is less than a predetermined value, the analyzing/computing unit generates a regression model with respect to each of the plurality of measurement data sets, and computes accuracy of each of the regression models, and selects a regression model having the highest accuracy as the computation result to thereby update the total phosphorus prediction model.
